(19) United States
(12) Patent Application Publication
(10) Pub. No.: US 2017/0200172 A1
(43) Pub. Date: Jul. 13, 2017

(54) CONSUMER DECISION TREE GENERATION SYSTEM

(71) Applicant: Oracle International Corporation, Redwood Shores, CA (US)

(72) Inventors: Su-Ming WU, Waltham, MA (US); John SHIN, Newton, MA (US); Kiran Venkata PANCHAMGAM, Bedford, MA (US)

(21) Appl. No.: 14/990,834

(22) Filed: Jan. 8, 2016

(51) Int. Cl. G06Q 30/02; G06N 5/02; G06Q 10/06

(52) U.S. Cl. CPC G06Q 30/0201; G06Q 10/067; G06N 5/02

(57) ABSTRACT

A system that generates a consumer decision tree receives retail item transactional sales data. The system aggregates the sales data to an item/store/time duration level and aggregates the sales data to an attribute-value/store/time duration level. The system determines sales shares for the time duration and determines similarities for attribute-value pairs based on correlations between attribute-value pairs. The system then determines a most significant attribute based on the determined similarities.

### FIELD

One embodiment is directed generally to a computer system, and in particular to a computer system that generates a consumer decision tree.

### BACKGROUND INFORMATION

Buyer decision processes are the decision making processes undertaken by consumers in regard to a potential market transaction before, during, and after the purchase of a product or service. More generally, decision making is the cognitive process of selecting a course of action from among multiple alternatives. Common examples include shopping and deciding what to eat.

In general there are three ways of analyzing consumer purchasing decisions: (1) Economic models—These models are largely quantitative and are based on the assumptions of rationality and near perfect knowledge. The consumer is seen to maximize their utility; (2) Psychological models—These models concentrate on psychological and cognitive processes such as motivation and need recognition. They are qualitative rather than quantitative and build on sociological factors like cultural influences and family influences; and (3) Consumer behavior models—These are practical models used by marketers. They typically blend both economic and psychological models.

One type of consumer behavior model is known as a “consumer decision tree” (“CDT”). A CDT is a graphical representation of a decision hierarchy of customers in a product attribute space for the purchase of an item in a given category. It models how customers consider different alternatives (based on attributes) within a category before narrowing down to the item of their choice, and helps to understand the purchasing decision of the customer. It is also commonly known as a “product segmentation and category structure”. CDTs are conventionally generated by brand manufacturers or third party market research firms based on surveys and other tools of market research. However, these methods lack accuracy and can lack authenticity since they may be based on biased data supplied by brand manufacturers.

### SUMMARY

One embodiment is a system that generates a consumer decision tree. The system receives retail item transactional sales data. The system aggregates the sales data to an item/store/time duration level and aggregates the sales data to an attribute-value/store/time duration level. The system determines sales shares for the time duration and determines similarities for attribute-value pairs based on correlations between attribute-value pairs. The system then determines a most significant attribute based on the determined similarities.

### BRIEF DESCRIPTION OF THE DRAWINGS

FIG. 1 is a block diagram of a computer server/system in accordance with an embodiment of the present invention.

FIG. 2 is an example CDT for a yogurt product category that is automatically generated based on a retailer's transactional data according to one embodiment.

FIG. 3 is a flow diagram of the functionality of the CDT generation module of FIG. 1 when generating a CDT in accordance with one embodiment.

FIG. 4 is a flow diagram of the functionality of the CDT generation module of FIG. 1 when determining similarities in accordance with one embodiment.

FIG. 5 is a flow diagram of the functionality of the CDT generation module of FIG. 1 when generating a CDT based on similarities in accordance with one embodiment.

FIG. 6 illustrates a CDT generated by the CDT generation module in accordance with one embodiment.

### DETAILED DESCRIPTION

One embodiment automatically generates a consumer decision tree (“CDT”) using a retailer's transactional data, specifically item-store-week aggregate sales-unit data, to determine item similarities. Therefore, transactional data available to even small retailers that do not make use of loyalty programs can be used to generate the CDT. Further, embodiments provide a determination of what items at a retailer belong together in a single category.

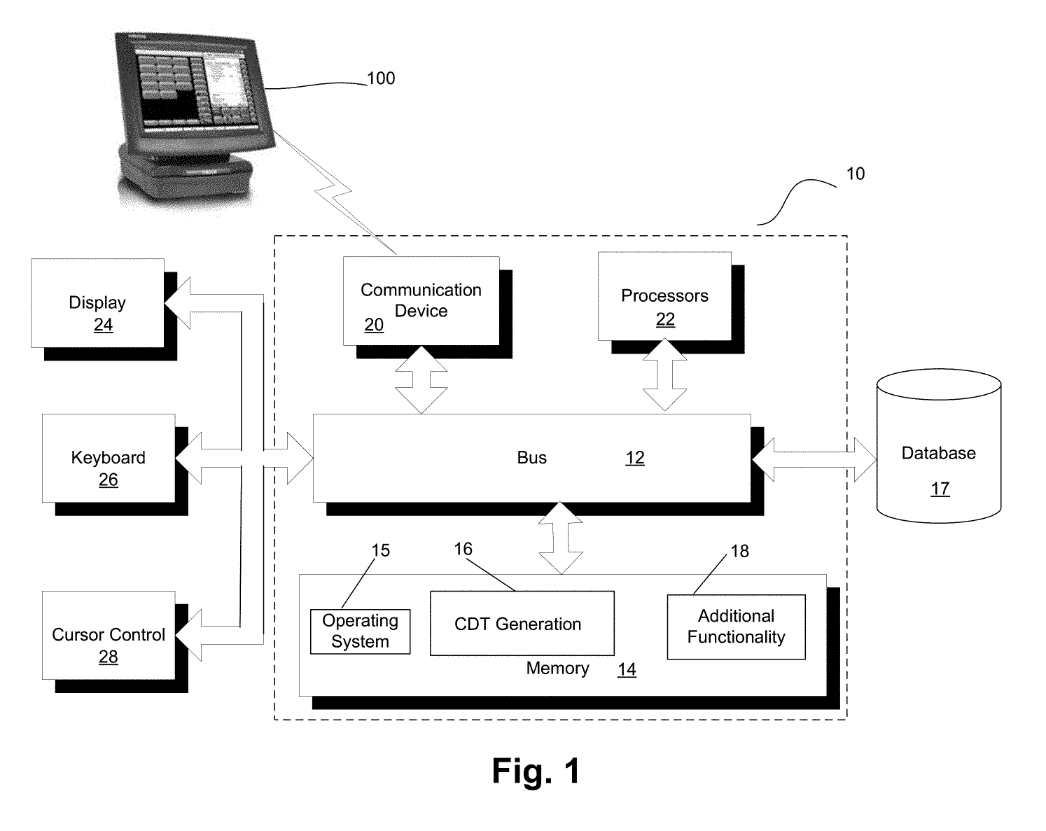

FIG. 1 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. For example, for functionality of a server, system 10 may need to include a processor and memory, but may not include one or more of the other components shown in FIG. 1, such as a keyboard or display.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include a consumer decision tree generation module 16 that automatically generates a CDT from retailer consumer data, and all other functionality disclosed herein. System 10 can be part of a larger system. Therefore, system 10 can include one or more additional functional modules 18 to include the additional functionality, such as a retail management system (e.g., the “Oracle Retail Merchandising System” or the “Oracle Retail Advanced Science Engine” (“ORASE”) from Oracle Corp.) or an enterprise resource planning (“ERP”) system. A database 17 is coupled to bus 12 to provide centralized storage for modules 16 and 18 and store customer data, product data, transactional data, etc. In one embodiment, database 17 is a relational database management system (“RDBMS”) that can use Structured Query Language (“SQL”) to manage the stored data. In one embodiment, a specialized point of sale (“POS”) terminal 100 generates the transactional data (e.g., item-store-week aggregate sales-unit data) used to generate CDTs. POS terminal 100 itself can include additional processing functionality to generate the CDTs in accordance with one embodiment.

As discussed, a CDT is a diagram that is standard in the retail industry and that depicts the importance that customers ascribe to the attributes of products sold by a retailer. Each category of products at a retailer may have its own customer decision tree describing the behavior of the customers who purchase products from that category. The attributes of a category are arranged in a tree, with the “most important” attribute at the root of the tree, and then the rest of the attributes arranged along the branches of the tree. The “most important” attribute indicates the attribute of the category that the customers of the category pay attention to first when purchasing a product from the category. The branches then give the order in which the customers of the category consider the rest of the attributes.

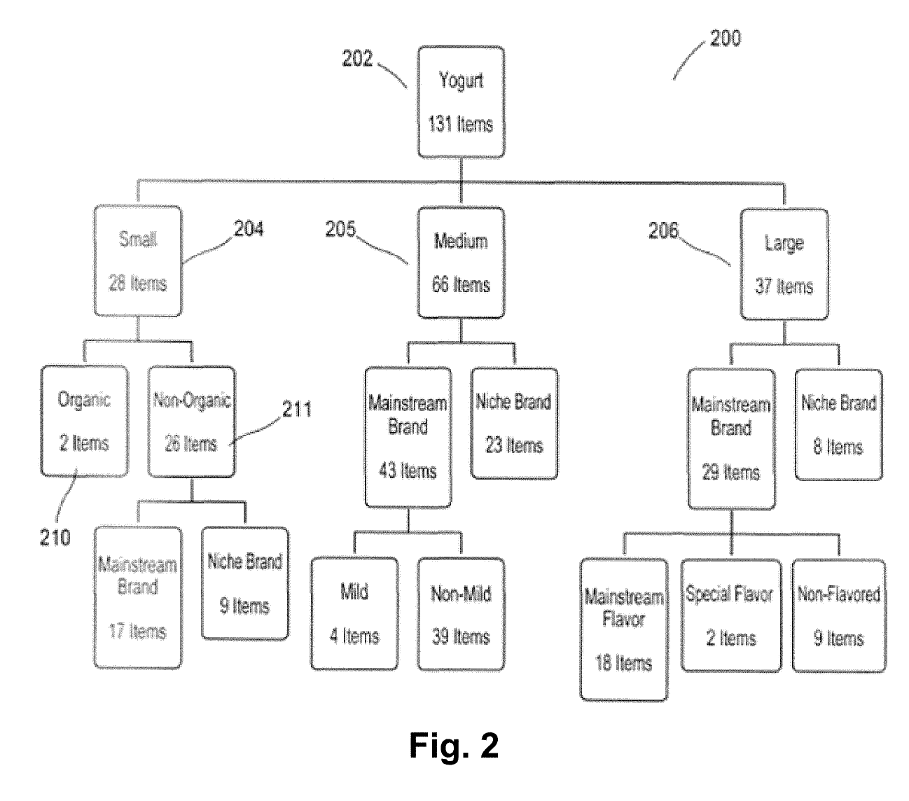

FIG. 2 is an example CDT 200 for a yogurt product category that is automatically generated by system 10 based on a retailer's transactional data according to one embodiment. As shown in FIG. 2, product attributes for the yogurt product category include size, brand, flavor, production method, etc. The attribute values for the “size” product attribute include small, medium and large. The attribute values for the “brand” product attribute include mainstream brand and niche brand. The attribute values for the “production method” production attributes include organic and non-organic. The attribute values for the “flavor” product attribute includes Non-Flavored, Mainstream Flavor and Special Flavor.

CDT 200 provides a retailer with an insight into the decision process of customers when purchasing yogurt. For example, CDT 200 indicates that, among the customers, the size 204-206 of the yogurt product 202 is generally the most important factor during the decision-making process since size is the first level attribute value beneath the category of yogurt. Then, depending on the preferred size, the brand or production method are considered as the second most important factors. For example, for those who prefer a small size, the production method (e.g., organic 210 or non-organic 211) is the second most important factor. However, for those who prefer a medium or large size item, the brand is the second most important factor, and the production method does not have any impact on the decision-making process. Also, the flavor does not have any impact on the decision-making process of those who prefer a small sized yogurt product although the flavor is also considered among those who prefer a medium or large sized yogurt product that are from a mainstream brand.

Historically, CDT generation was not an automated process. Historical approaches to CDT generation frequently involved hiring industry experts to interview customers and examine in-store customer behavior, and the experts would then derive a CDT by hand. One known automated solution is disclosed in U.S. Pat. No. 8,874,499, which derives a CDT for each category by using the retailer's historical transactions data from the category. However, this known solution requires that the retailer be able to separate the historical transactions of a category by customer, using for example customer loyalty cards. It also requires that the same customer make multiple purchases in the category within a relatively short period of time. These requirements on the transactions data allows the system to calculate attribute importance by examining the “switching behavior” of customers of the category, meaning that when customers did not always stick to a single product in the category, what other products in the category did they purchase. Because this known solution examined such “switching behavior”, it can only calculate CDTs for categories where the historical transactions data can be identified by customer AND where the category is one in which customers typically make multiple purchases. Otherwise there is no switching behavior to examine.

Therefore, for some situations, there are many categories and many retailers for which these known solutions are unsuitable. For example, many retailers, particularly smaller ones, do not implement a loyalty card program due to its high cost. Further, many retailers sell categories where frequent purchases by the same customer are extremely unlikely. This describes most electronics categories, for example. Even a retailer who has many suitable categories, such as a grocer, will likely have categories that are unsuitable, such as pots and pans at a grocer.

In contrast, embodiments of the present invention use item-store-week aggregate sales-unit data, which is data generated by virtually every retailer, even without the use of a customer loyalty program. Therefore, embodiments can be used by a wide range of retailers, including relatively small retailers that cannot afford to implement a costly loyalty card program. Further, embodiments can determine a CDT for categories of products that are not frequently purchased, such as cellular telephones and televisions.

Further, embodiments can determine what items belong together in a category. Though frequently it is clear what items a category consists of, such as the yogurt category at a grocer, there are many retailers where the categories are less clear. For example, at Disney stores, it can be unclear what a category is, because when customers, particularly children, buy something at the store, they frequently do not care what the function of the item actually is as long as it has a particular Disney character on it. Therefore, for example, pens may in fact cannibalize mugs, and so although pens and mugs would normally be separate categories of items, they should not be at a Disney store. Further, for pet grooming products, different types of dog grooming tools can serve the same function and therefore cannibalize each other even though the tools themselves are actually different.

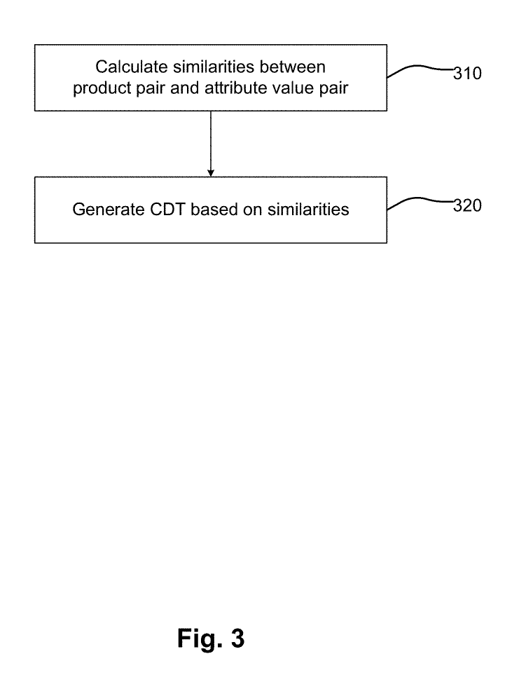

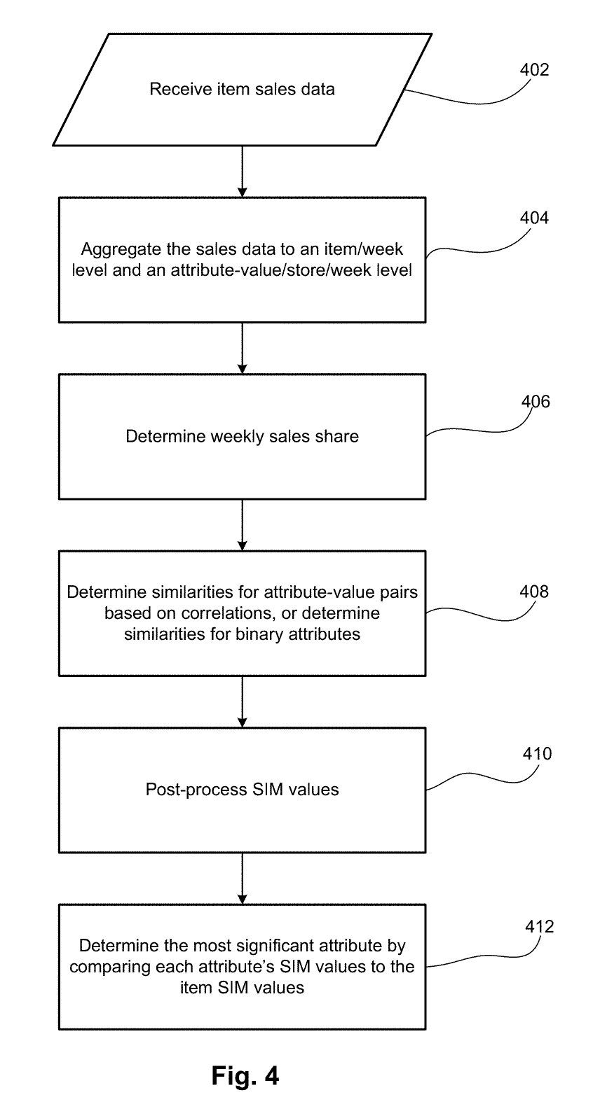

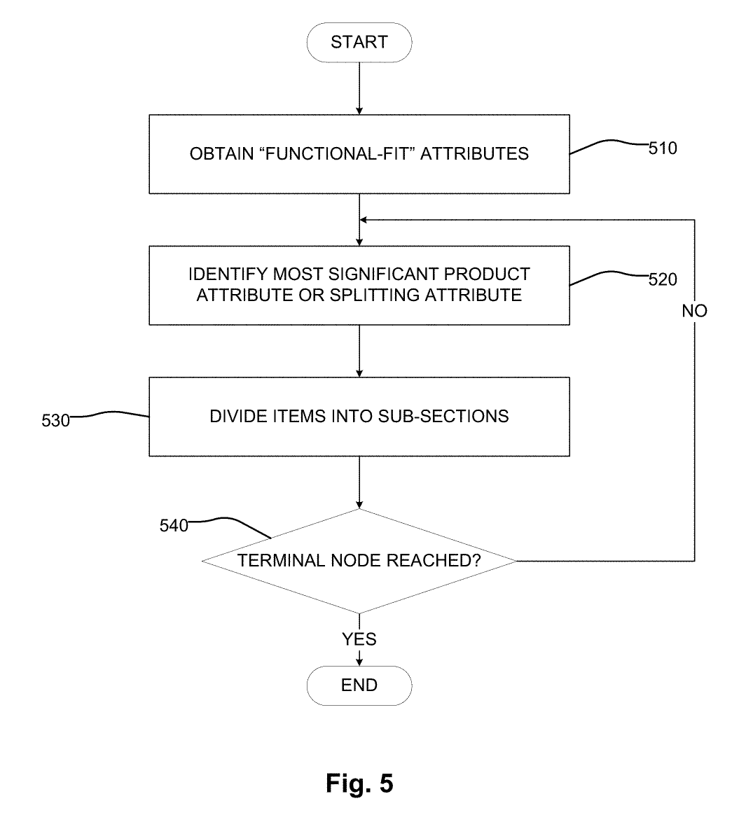

FIG. 3 is a flow diagram of the functionality of CDT generation module 16 of FIG. 1 when generating a CDT in accordance with one embodiment. In one embodiment, the functionality of the flow diagram of FIG. 3 (and FIGS. 4 and 5 below) is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

In FIG. 3, at 310, CDT generation module 16 calculates similarities between each product pair and each attribute value pair. Then, at 320, CDT generation module 16 generates the CDT based on the similarities from 310.

FIG. 4 is a flow diagram of the functionality of CDT generation module 16 of FIG. 1 when determining similarities at 310 of FIG. 3 in accordance with one embodiment. In calculating the similarities at 310, similarities between each product pair and attribute value pair for a given category are determined. In general, embodiments first receive data elements in the form of sales data from, for example, POS terminal 100. The data is then aggregated, and then weekly sales share is calculated. Then, the similarity calculations are performed for attribute-value pairs.

As for the data elements, at 402 sales data is received at the transaction level (i.e., transaction ID/customer ID/store/date/item) level. A transaction is an occurrence of a sale as identified by a combination of a customer identification (“ID”), a transaction ID, a store ID, a date, and the item that was purchased, with accompanying information such as the number of units sold, the amount sold in $, and the sales price of the item. This information is readily available in most POS systems for individual retail stores. Table 1 below illustrates example of transactional data, showing different customers purchasing the same item (i.e., item ID is 2345) for a given store (i.e., store ID is 142) on a given day.

TABLE 1

| transaction_id | customer_id | store_id | item_id | date | unit sales | sales amount | sales price |
|---|---|---|---|---|---|---|---|
| 15960247 | 584231 | 142 | 2345 | May 11, 2015 | 34 | $305.66 | $8.99 |
| 15960248 | 345634 | 142 | 2345 | May 11, 2015 | 12 | $107.88 | $8.99 |
| 15960249 | 657856 | 142 | 2345 | May 12, 2015 | 10 | $79.90 | $7.99 |
| 15360250 | 123123 | 142 | 2345 | May 12, 2015 | 5 | $29.95 | $5.99 |
| 15960251 | 435436 | 142 | 2345 | May 14, 2015 | 50 | $449.50 | $8.99 |

At 404, the data is then aggregated to an item/week level. In other embodiments, a different time duration/measurement other then week can be used (e.g., day, month, etc.). In one embodiment, the transaction-level data is aggregated to an item/store/week level across all transaction IDs and customer IDs for that given item/store/week. Sales units and $ are now reflective of this level. The sales price is now defined as a weighted average price: sum of $ sold/sum of units sold. Using the above example in Table 1, the aggregated item/store/week level data now becomes the following shown in Table 2 for the week-ending 5/16/2015.

TABLE 2

| | | | | sales | weighted |
|---|---|---|---|---|---|
| store_id | item_id | date | unit sales | amount | price |
| 142 | 2345 | May 16, 2015 | 111 | $972.89 | $8.76 |

At 404, the data is further aggregated to an attribute-value/store/week level. In other embodiments, a different time duration/measurement other then week can be used (e.g., day, month, etc.). In one embodiment, each item has a product attribute type and value, and their collective sales are reflected at this level. Example of attribute types are flavor (e.g., values of “strawberry” or “vanilla”), size (e.g., values of “small”, “medium” or “large”), brand (e.g., values of “Coke” or “Pepsi”), etc. Table 3 below is an example that displays the sales for the Flavor attribute.

TABLE 3

| | | | | sales | sales |
|---|---|---|---|---|---|
| store_id | Flavor value | date | unit sales | amount | price |
| 2345 | Flavor 1 | May 16, 2015 | 111 | $972.89 | $8.76 |
| 2345 | Flavor 2 | May 16, 2015 | 23 | $184.23 | $8.01 |
| 2345 | Flavor 3 | May 16, 2015 | 133 | $1,243.55 | $9.35 |
| 2345 | Flavor 3 | May 23, 2015 | 78 | $692.64 | $8.88 |
| 2345 | Flavor 3 | May 30, 2015 | 45 | $413.55 | $9.19 |

Using the aggregated data, embodiments next at 406 determine the weekly sales share, or if not weekly, the sales share during the relevant time measurement. In one embodiment, the weekly sales share is the percent of sales belonging to an attribute value/store/week compared to all other attribute values for the same attribute type over the same store/week. For a given store/week, the sum of sales shares for a given attribute type add up to 100%. Embodiments determine the weekly sales share for all attribute type/store/weeks in the data history.

Continuing with above example, Table 4 below shows, for the week of 5/16/15, sales share=a flavor's unit sales/total week unit sales.

TABLE 4

| store_id | Flavor value | date | unit sales | sales share |
|---|---|---|---|---|
| 2345 | Flavor 1 | May 16, 2015 | 111 | 41.6% |
| 2345 | Flavor 2 | May 16, 2015 | 23 | 8.6% |
| 2345 | Flavor 3 | May 16, 2015 | 133 | 49.8% |
| | | Total | 267 | 100% |

Weekly sales shares are also computed for all items across a store/week. Table 5 below shows an example.

TABLE 5

| store_id | item_id | date | unit sales | sales share |
|---|---|---|---|---|
| 1001 | 123456 | May 16, 2015 | 22 | 26.5% |
| 1001 | 654321 | May 16, 2015 | 44 | 53.0% |
| 1001 | 881155 | May 16, 2015 | 5 | 6.0% |
| 1001 | 265446 | May 16, 2015 | 12 | 14.5% |
| | | Total | 83 | 100% |

At 408, embodiments then determine similarities for attribute-value pairs. In one embodiment, similarities are computed within an attribute type across its sales share history and are computed using the Pearson correlation formula as follows:

$$SIM ( X , Y ) = \frac{{\sum }_{i = 1}^{n} {X}_{i} {Y}_{i} - \frac{( {\sum }_{i = 1}^{n} {X}_{i} ) ( {\sum }_{i = 1}^{n} {Y}_{i} )}{n}}{\sqrt{( {\sum }_{i = 1}^{n} {X}_{i}^{2} - \frac{{( {\sum }_{i = 1}^{n} {X}_{i} )}^{2}}{n} ) ( {\sum }_{i = 1}^{n} {Y}_{i}^{2} - \frac{{( {\sum }_{i = 1}^{n} {Y}_{i} )}^{2}}{n} )}} \qquad ( Equation 1 )$$

where for a flavor pair (X, Y), Xᵢ and Yᵢ represent the store/week share values for the flavor X and Y, respectively, and n represents the total number of store/weeks where there are flavor shares for X and Y.

Embodiments calculate SIM(X, Y) for all pairs of flavors (X, Y). These similarities constitute the “flavor similarities”. The formula for SIM shown above will always produce a number between −1 and 1. A SIM close to −1 for attribute values X and Y means that the shares of X and Y are “anti-correlated,” meaning when the share of X goes up, the share of Y goes down and vice versa. Thus, when customers are buying more of X, they are buying less of Y (and vice versa), and therefore X and Y must be similar to the customer in that they are replacements for each other. The closer to −1, the more of a replacement X and Y are for each other. In the same manner, embodiments also calculate similarities for every other attribute, and therefore obtains for example, “brand similarities,” “size similarities,” etc.

In one embodiment, the correlations described above are calculated using the built-in function, “corn”, in SQL, using the following pseudo-code:

select

x.flavor as flavor_x, y.flavor as flavor_y,
corr(x.flavor_share, y.flavor_share) as flavor_similarity

from

sales_share_table x,
sales_share_table y

where

x.calendar_wk = y.calendar_wk
and x.flavor <= y.flavor

group by

flavor1, flavor2

with a result as shown in Table 6 below:

TABLE 6

| flavor_x | flavor_y | flavor_similarity |
|---|---|---|
| flavor_1 | flavor_1 | 1.00 |
| flavor_1 | flavor_2 | −0.45 |
| flavor_1 | flavor_3 | −0.15 |
| flavor_2 | flavor_2 | 1.00 |
| flavor_2 | flavor_3 | 0.05 |
| flavor_3 | flavor_3 | 1.00 |

A similar process is repeated for item pairs, where X and Y represent two different items (instead of attribute values as in the above.) and thus X_{I} and Yᵢ represent the item shares of item X and item Y, respectively, at a particular store/week. Therefore, embodiments calculate SIM(X, Y) for each pair of items (X, Y), just as embodiments calculated SIM(X, Y) above for each pair of attribute values of an attribute with the following example results shown in Table 7 below:

TABLE 7

| item_x | item_y | item_similarity |
|---|---|---|
| 2345 | 2345 | 1.00 |
| 2345 | 5791 | −0.34 |
| 2345 | 9876 | 0.21 |
| 5791 | 5791 | 1.00 |
| 5791 | 9876 | −0.56 |
| 9876 | 9876 | 1.00 |

At 408, embodiments further perform similarity calculations for binary attributes. A binary attribute is an attribute which has only two values. These are quite common, and typically indicate the presence or absence of some property. One example used below is “organic” (i.e., a food item is either organic or not). Binary attributes require special handling, because if the formula for SIM given above is simply applied, the result will always be SIM=−1, which does not provide information about how shoppers are treating the attribute.

Instead, for those attribute types with only two values to choose from, (e.g., organic and non-organic food), the correlation is calculated as the following:

$$2 \sqrt{\frac{{\sum }_{k = 1}^{N} {( {x}_{k} - \overline{x} )}^{2}}{N}} \qquad ( Equation 2 )$$

Where xₖ is the organic share in week k, and there is N weeks. x̅ is the average of the xᵢ, that is, the average organic share over the N weeks. Thus, Equation 2 is 2 times the standard deviation of xₖ, and is measuring the fluctuations of the organic share away from the average organic share. In general, the more fluctuation, the more the customers were trading organics for non-organic (or vice versa), and thus the more similar organic is to non-organic. If xₖ is instead used as the non-organic share (and x̅ as the average non-organic share), the same number will result. The multiplier of 2 is used to make the measure go from 0 to 1 (otherwise the measure will go from 0 to ½, since ½ is the maximum of standard deviation if the xₖ are between 0 and 1, which they are here because they are shares).

The following SQL pseudo-code can be used to perform similarity for binary attributes:

sum(2/sqrt(n_wks)*sqrt(sum(power(abs(a.share_organic −
stats.avg_share_organic),2)))
as organic_similarity,
2/sqrt(n_wks)*sqrt(sum(power(a.share_nonorganic −
stats.avg_share_nonorganic,2)))
as nonorganic_similarity

from

(select

```
avg(share_organic) as avg_share_organic,
  avg(share_nonorganic) as avg_share_nonorganic,
  count(*) as n_wks
```

from

sales_share_organic_values_table) stats,

sales_share_organic_values_table a

group by

n_wks

Example results for the similarity calculations for binary attributes are shown in Table 8 below:

TABLE 8

| organic_similarity | nonorganic_similarity |
|---|---|
| 0.43 | 0.43 |

At 410, embodiments then post-process the SIM values. In the SIM values for both the attribute-pairs and the item pairs, embodiments modify the SIM values as follows: if a SIM value is positive, set it to 0; and if it is negative, make it positive. For the remainder of the disclosure, the SIM values that are used are the post-processed SIM values. The post-processing at 410 is not used for similarities of binary attribute types, since Equation 2 above guarantees that those are already non-negative.

At 412, embodiments then find the “most significant attribute”, by comparing each attribute's SIM values to the item SIM values. Embodiments determine which attribute best explains the item-level purchasing behavior of the customers. The item-level SIM values are compared with the SIM values of each attribute, and the attribute whose SIM values most closely “match” (disclosed below) the item-level values is found.

For a particular attribute, such as Flavor, embodiments compile the item and attribute SIM values into one table, as shown in Table 9 below. The flavor_x column gives the flavor of item_x, and similarly flavor_y gives the flavor of item_y. The flavor_similarity gives the SIM value of flavor_x and flavor_y. Note that if flavor_x and flavor_y are the same (because item_x and item_y are the same flavor), then the flavor_similarity equals 1 because the flavors are the same. Otherwise it is just the SIM value of flavor_x and flavor_y, calculated as previously described.

TABLE 9

| item_x | flavor_x | item_y | flavor_y | item_similarity | flavor_similarity |
|---|---|---|---|---|---|
| 4563 | flavor_1 | 1200 | flavor_3 | 0.58 | 0.45 |
| 4563 | flavor_1 | 2345 | flavor_1 | 0.82 | 1.00 |
| 4563 | flavor_1 | 4563 | flavor_1 | 1.00 | 1.00 |
| 4563 | flavor_1 | 5665 | flavor_2 | 0.67 | 0.68 |
| 4563 | flavor_1 | 5698 | flavor_4 | 0.65 | 0.21 |
| 4563 | flavor_1 | 8758 | flavor_1 | 0.02 | 1.00 |
| 4563 | flavor_1 | 9901 | flavor_2 | 0.10 | 0.68 |
| 5665 | flavor_2 | 1200 | flavor_3 | 0.05 | 0.50 |
| 5665 | flavor_2 | 2345 | flavor_1 | 0.98 | 0.68 |
| 5665 | flavor_2 | 5665 | flavor_2 | 1.00 | 1.00 |
| 5665 | flavor_2 | 5698 | flavor_4 | 0.68 | 0.29 |
| 5665 | flavor_2 | 8758 | flavor_1 | 0.34 | 0.68 |
| 5665 | flavor_2 | 9901 | flavor_2 | 0.58 | 1.00 |
| 1200 | flavor_2 | 1200 | flavor_3 | 1.00 | 0.50 |
| 1200 | flavor_2 | 5698 | flavor_4 | 0.12 | 0.29 |
| 1200 | flavor_3 | 8758 | flavor_1 | 0.24 | 0.45 |
| . . . | . . . | . . . | . . . | . . . | . . . |

Embodiments then run the correlation calculation on the item and attribute similarities (in the example of Table 9, this would refer to the item_similarity and flavor_similarity values) using the following SQL pseudo-code. This means running correlation on the item_similarity and flavor_similarity columns:

select

corr(item_similarity, flavor_similarity) as flavor_result

from

item_flavor_similarities

with an example result shown in Table 10 below:

TABLE 10
flavor_result
0.0804

Embodiments then repeat for all attributes and compile the results as shown in the below example of Table 11:

TABLE 11

| | attribute_result |
|---|---|
| brand_result | 0.1559 |
| organic_result | 0.1235 |
| size_result | 0.0912 |
| flavor_result | 0.0804 |

The attribute with the largest value is considered to have the most significance in the CDT, and thus would be the top level attribute of the CDT that is generated at 320 of FIG. 3. To add to the CDT, the functionality of FIG. 4 is repeated to produce the other levels and branches of the CDT. For example, once it is determined that “Brand” is the top-most attribute, the functionality of FIG. 4 is executed for each brand in the Brand attribute, but using only the subset of the data elements received at 402 that are within a particular brand.

FIG. 5 is a flow diagram of the functionality of CDT generation module 16 of FIG. 1 when generating a CDT based on similarities (320 of FIG. 3) in accordance with one embodiment. At 510, it is determined whether there are any functional-fit attributes in the products of the same product category. A functional-fit attribute is a product attribute for which substitution across its values is extremely unlikely. For example, a customer who is shopping for wiper blades must purchase blades that fit the corresponding car. Therefore, in the wiper blade product category, the “size” product attribute is determined as the functional-fit attribute. The “size” product attribute could be also a functional-fit attribute for other product categories, for example, tires, air filters, vacuum bags, printer cartridges, etc. However, the same “size” product attribute may not be a functional-fit attribute for other product categories, for example, fruits, soft drinks, etc. In general, functional-fit attributes are typically present in non-grocery items such as accessories, etc. The functional-fit attributes in one embodiment are obtained directly from the generated customer data, and will typically not have to be calculated. For example, a retailer will typically explicitly identify what the “functional fit” attributes are, for example, explicitly stating that size in the case of wiper blades is a functional-fit attribute.

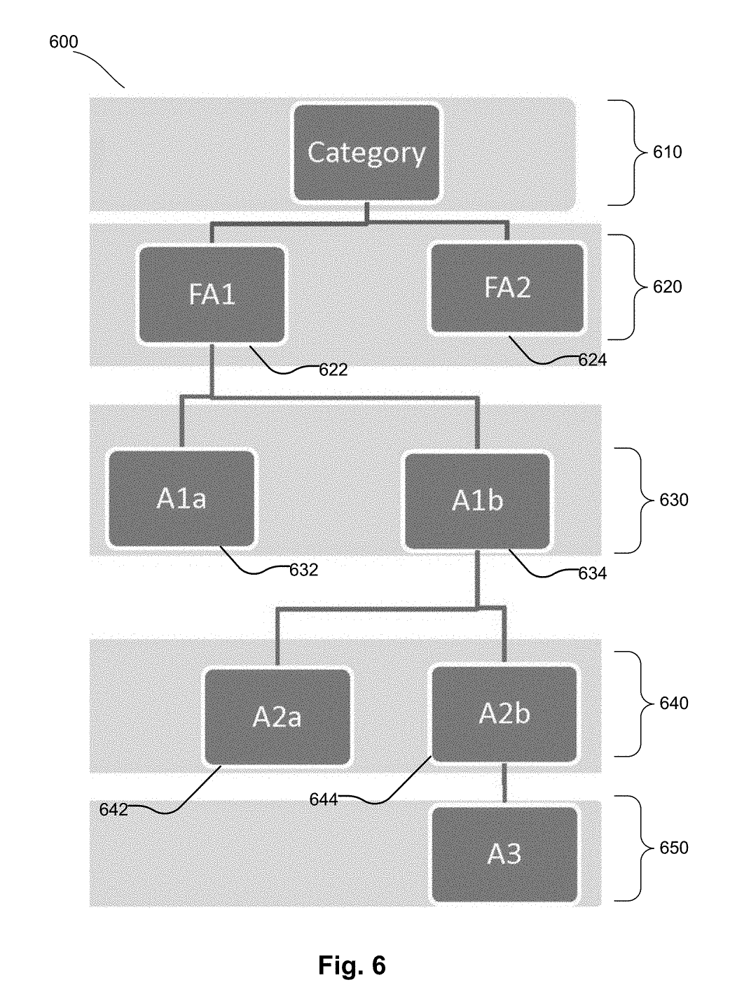

After all functional-fit attributes are identified, the functional-fit attributes are automatically placed at the top level of the CDT directly under the product category. FIG. 6 illustrates a CDT 600 generated by CDT generation module 16 in accordance with one embodiment. CDT 600 has a category level 610, which identifies the product category. For a yogurt product category, “Yogurt” would be displayed in category level 610, as shown in FIG. 2. In another example, for a “Coffee” category, “Coffee” is displayed in category level 610. Then, the functional-fit attributes are placed at a top level 620 of CDT 600. FIG. 6 shows two functional-fit attributes (FA1, FA2) 622, 624 at top level 620. However, for Yogurt or Coffee, there likely would not be any functional-fit attributes.

At 520 of FIG. 5, the most significant attribute or a splitting attribute is then identified. The most significant attribute is determined in accordance with the functionality of FIG. 4.

At 530, the items are divided into sub-sections, where each sub-section corresponds to a particular attribute value of the attribute identified at 520. For example, when a “form” product attribute is determined to be the most significant attribute for coffee at 520, “form” product attribute is divided into three sub-sections, each corresponding to a particular value of form for coffee: “Bean,” “Ground,” and “Instant.” The sub-sections form a next level 630 in FIG. 6 that is below top level 620. For example, FIG. 6 shows two sub-sections (A1a, A1b) 632, 634 in level 630, which are branched out from functional-fit attribute 622. 520 and 530 are repeated for each sub-section and CDT 600 is expanded until a terminal node is reached (No at 540) for each sub-section. If a terminal node is finally reached for each sub-section (Yes at 540), the process is terminated.

As disclosed, the tree is expanded until a terminal node is identified. In one embodiment, the criteria to declare a node as terminal is as follows:
1. No significant attribute is identified.
2. The number of items in a node <x % of the total items in a product category, where “x” is a tuning parameter which caps the size of the tree. In one embodiment, the default value for x is 10.
3. The Average Dissimilarity (“AD”) (i.e., the average over all possible pairs of products in the node) of a child node is greater than its parent node. Two possible sub-cases as as follows:
   a. If all the children nodes have their AD values greater than the parent node then the parent node is declared the terminal node.
   b. If some of the children nodes have their AD values greater than the parent node then those nodes are terminated and other children nodes are expanded in regular fashion.

As disclosed embodiments generate CDTs while relying only on item-store-week aggregate sales-units data. Such data is generally available from every retailer, regardless of category, as item-store-week aggregate sales-units data is merely a weekly total of the number of units sold of each item at each store. Therefore, more difficult or costly to obtain data, such as an identity of a customer, is not required.

Further, known CDT generation systems from aggregate data generally rely on more standard statistical approaches, which despite being standard have shortcomings for use in calculating CDTs. These known approaches can require very large amounts of computing power, and may be difficult to implement. In contrast, embodiments can be implemented with standard SQL queries, and run very quickly even on large customer data sets.

Further, embodiments handle attributes that have only two values (known as Boolean attributes). Such attributes are quite common in many categories, as they signal the presence or absence of some property in items in the category (for example whether yogurt is a Greek yogurt or not, or whether a shampoo is hypo-allergenic).

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, cause the processor to generate a consumer decision tree (CDT), the generating comprising:
receiving retail item transactional sales data;
aggregating the sales data to an item/store/time duration level;
aggregating the sales data to an attribute-value/store/time duration level;
determining sales shares for the time duration;
determining similarities for attribute-value pairs based on correlations between attribute-value pairs; and
determining a most significant attribute based on the determined similarities.

2. The computer readable medium of claim 1, wherein the time duration comprises weekly.

3. The computer readable medium of claim 1, the generating further comprising:
determining similarities for binary attributes.

4. The computer readable medium of claim 1, the generating further comprising post-processing the determined similarities comprising assigning a positive value to 0 and revising a negative value to a corresponding positive value.

5. The computer readable medium of claim 1, wherein the determining similarities for attribute-value pairs comprises determining a value for SIM comprising:
$$SIM ( X , Y ) = \frac{{\sum }_{i = 1}^{n} {X}_{i} {Y}_{i} - \frac{( {\sum }_{i = 1}^{n} {X}_{i} ) ( {\sum }_{i = 1}^{n} {Y}_{i} )}{n}}{\sqrt{( {\sum }_{i = 1}^{n} {X}_{i}^{2} - \frac{{( {\sum }_{i = 1}^{n} {X}_{i} )}^{2}}{n} ) ( {\sum }_{i = 1}^{n} {Y}_{i}^{2} - \frac{{( {\sum }_{i = 1}^{n} {Y}_{i} )}^{2}}{n} )}} \qquad$$
wherein for an attribute-value pair (X, Y), Xᵢ and Yᵢ represent the store/time share values for the attribute X and Y, and n represents the total number of store/time duration where there are attribute shares for X and Y.

6. The computer readable medium of claim 3, wherein the determining similarities for binary attributes comprises:
$$2 \sqrt{\frac{{\sum }_{k = 1}^{N} {( {x}_{k} - \overline{x} )}^{2}}{N}}$$
wherein xₖ is the organic share in time duration k, and there is N time durations, and x̅ is the average of the xᵢ.

7. The computer readable medium of claim 1, the generating further comprising:
assigning the most significant attribute as a first level of the CDT;
dividing a second level of the CDT into a plurality of sub-sections, wherein each sub-section corresponds to an attribute value of the most significant attribute;
for each sub-section, repeating, for the sub-section value, the receiving retail item transactional sales data, aggregating the sales data to the item/store/time duration level, aggregating the sales data to an attribute-value/store/time duration level, determining sales shares for the time duration, determining similarities for attribute-value pairs based on correlations between attribute-value pairs, and determining the most significant attribute based on the determined similarities.

8. A method of generating a consumer decision tree (CDT), the method comprising:
receiving retail item transactional sales data;
aggregating the sales data to an item/store/time duration level;
aggregating the sales data to an attribute-value/store/time duration level;
determining sales shares for the time duration;
determining similarities for attribute-value pairs based on correlations between attribute-value pairs; and
determining a most significant attribute based on the determined similarities.

9. The method of claim 8, wherein the time duration comprises weekly.

10. The method of claim 8, further comprising:
determining similarities for binary attributes.

11. The method of claim 8, further comprising post-processing the determined similarities comprising assigning a positive value to 0 and revising a negative value to a corresponding positive value.

12. The method of claim 8, wherein the determining similarities for attribute-value pairs comprises determining a value for SIM comprising:
$$SIM ( X , Y ) = \frac{{\sum }_{i = 1}^{n} {X}_{i} {Y}_{i} - \frac{( {\sum }_{i = 1}^{n} {X}_{i} ) ( {\sum }_{i = 1}^{n} {Y}_{i} )}{n}}{\sqrt{( {\sum }_{i = 1}^{n} {X}_{i}^{2} - \frac{{( {\sum }_{i = 1}^{n} {X}_{i} )}^{2}}{n} ) ( {\sum }_{i = 1}^{n} {Y}_{i}^{2} - \frac{{( {\sum }_{i = 1}^{n} {Y}_{i} )}^{2}}{n} )}} \qquad$$
wherein for an attribute-value pair (X, Y), Xᵢ and Yᵢ represent the store/time share values for the attribute X and Y, and n represents the total number of store/time duration where there are attribute shares for X and Y.

13. The method of claim 10, wherein the determining similarities for binary attributes comprises:
$$2 \sqrt{\frac{{\sum }_{k = 1}^{N} {( {x}_{k} - \overline{x} )}^{2}}{N}}$$
wherein xₖ is the organic share in time duration k, and there is N time durations, and x̅ is the average of the xᵢ.

14. The method of claim 8, further comprising:
assigning the most significant attribute as a first level of the CDT;
dividing a second level of the CDT into a plurality of sub-sections, wherein each sub-section corresponds to an attribute value of the most significant attribute;
for each sub-section, repeating, for the sub-section value, the receiving retail item transactional sales data, aggregating the sales data to the item/store/time duration level, aggregating the sales data to an attribute-value/store/time duration level, determining sales shares for the time duration, determining similarities for attribute-value pairs based on correlations between attribute-value pairs, and determining the most significant attribute based on the determined similarities.

15. A consumer decision tree (CDT) generation system, comprising:
an aggregating module that, in response to receiving retail item transactional sales data, aggregates the sales data to an item/store/time duration level and aggregates the sales data to an attribute-value/store/time duration level; and
a similarity module that determines sales shares for the time duration, determines similarities for attribute-value pairs based on correlations between attribute-value pairs, and determines a most significant attribute based on the determined similarities.

16. The system of claim 15, wherein the determining similarities for attribute-value pairs comprises determining a value for SIM comprising:
$$SIM ( X , Y ) = \frac{{\sum }_{i = 1}^{n} {X}_{i} {Y}_{i} - \frac{( {\sum }_{i = 1}^{n} {X}_{i} ) ( {\sum }_{i = 1}^{n} {Y}_{i} )}{n}}{\sqrt{( {\sum }_{i = 1}^{n} {X}_{i}^{2} - \frac{{( {\sum }_{i = 1}^{n} {X}_{i} )}^{2}}{n} ) ( {\sum }_{i = 1}^{n} {Y}_{i}^{2} - \frac{{( {\sum }_{i = 1}^{n} {Y}_{i} )}^{2}}{n} )}}$$
wherein for an attribute-value pair (X, Y), Xᵢ and Yᵢ represent the store/time share values for the attribute X and Y, and n represents the total number of store/time duration where there are attribute shares for X and Y.

17. The system of claim 15, the similarity module further determining similarities for binary attributes comprising:
$$2 \sqrt{\frac{{\sum }_{k = 1}^{N} {( {x}_{k} - \overline{x} )}^{2}}{N}}$$
wherein xₖ is the organic share in time duration k, and there is N time durations, and x̅ is the average of the xᵢ.

18. The system of claim 15, wherein the time duration comprises weekly.

19. The system of claim 15, the similarity module further post-processing the determined similarities comprising assigning a positive value to 0 and revising a negative value to a corresponding positive value.

20. The system of claim 15, further comprising:
a level generation module that assigns the most significant attribute as a first level of the CDT, divides a second level of the CDT into a plurality of sub-sections, wherein each sub-section corresponds to an attribute value of the most significant attribute, and
for each sub-section, repeats, for the sub-section value, the receiving retail item transactional sales data, aggregating the sales data to the item/store/time duration level, aggregating the sales data to an attribute-value/store/time duration level, determining sales shares for the time duration, determining similarities for attribute-value pairs based on correlations between attribute-value pairs, and determining the most significant attribute based on the determined similarities.
